(19) United States
(12) Patent Application Publication
(10) Pub. No.: US 2011/0088309 A1
(43) Pub. Date: Apr. 21, 2011

(54) DEVICE FOR CAPTURING INSECTS

(75) Inventors: Uriel Kitron, Atlanta, GA (US); Gonzalo M. Vazquez-Prokopec, Atlanta, GA (US); William A. Galvin, Decatur, GA (US)

(73) Assignee: EMORY UNIVERSITY OFFICE OF TECHNOLOGY TRANSFER, Atlanta, GA (US)

(21) Appl. No.: 12/898,280

(22) Filed: Oct. 5, 2010

Related U.S. Application Data
(60) Provisional application No. 61/248,652, filed on Oct. 5, 2009.

(51) Int. Cl. A01M 5/02

(52) U.S. Cl. 43/107

(57) ABSTRACT

In one aspect, a device for capturing at least one living subject is disclosed. In one embodiment, the device has a housing means with a body portion defined between a first end and a second end and forming a bore inside along the longitudinal axis. An airflow generation means and a connected driving means are disposed within the housing means, and a collection means with a filter portion is received at least partially within the housing means. A handle means is connected to the housing means, and a power source means is connected to the driving means and physically separated from the housing means.

### CROSS-REFERENCE TO RELATED PATENT APPLICATION

This application claims priority to and the benefit of, pursuant to 35 U.S.C. §119(e), U.S. provisional patent application Ser. No. 61/248,652, filed Oct. 5, 2009, entitled “Device and

Methods for Capturing Insects,” by Uriel Kitron, Gonzalo M. Vazquez-Prokopec, and William A. Galvin, the content of which is herein incorporated by reference in its entirety.

Some references, if any, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference. In terms of notation, hereinafter, “[n]” represents the nth reference cited in the reference list. For example, [2] represents the 2nd reference cited in the reference list, namely, Silver, J. B., Mosquito Ecology: Field Sampling Methods, Springer, N.Y., 3rd ed., 2008.

### FIELD OF THE INVENTION

The present invention generally relates to a device for capturing a living subject and in particular to a device for capturing at least one insect.

### BACKGROUND OF THE INVENTION

Knowledge of adult mosquito population density is paramount to the understanding of host vector contacts, pathogen inoculation rates, and, ultimately, vector-borne disease transmission risk [1,2]. While some mosquito collection methods exist, they have limitations in their sensitivity and bias towards preferentially collecting mosquitoes of certain stages or nutritional states, or are limited operationally by their cost or convenience for massive and long-term deployment [2]. Human landing-biting and pyrethroid knock-down collections are time and personnel consuming, subject to inter-operator and location heterogeneity and impractical in many urban environments [2]. Active traps are biased towards collections of female and target particular species and life stages or nutritional status [2]. In addition, the high cost and the dependence on personnel for setup and recovery preclude their use for large-scale collections, particularly in resource-poor settings.

Powered aspirators collect mosquitoes of both sexes and all physiological stages

directly from their resting sites, allowing better estimations of richness (number of different mosquito species in a given area), abundance, sex ratio, age structure and physiological condition of sampled populations [2]. However, conventional aspirators can be heavy and difficult to maneuver in confined spaces. This can dramatically limit the ability to aspirate mosquitoes indoors, particularly in elevated and out of reach locations such as upper walls, ceilings, and under beds. Consequently, conventional collectors commonly yield low capture rates [3]. Further, because conventional aspirators involve the use of high velocity air for suction, mosquitoes are often inadvertently killed during the collection process, thereby limiting the number of collected mosquitoes that can be researched in a living state [4]. In addition, conventional powered aspirators are very expensive, which limits their potential for widespread mosquito surveillance.

Therefore, a heretofore unaddressed need still exists in the art to address the aforementioned deficiencies and inadequacies.

### SUMMARY OF THE INVENTION

The present invention, in one aspect, relates to a device for capturing at least one living subject. In one embodiment, the device includes a housing having a first end defining a first opening, an opposite second end defining a second opening, and a body portion defined between the first end and the second end and forming a bore inside along the longitudinal axis. An airflow generation means is operatively associated with the housing, and a driving means operatively associated with the airflow generation means. A collection means is received at least partially within the housing and has a first end defining an opening proximate the first opening of the housing, an opposite, second end, and a body portion defined between the first end and the second end. At least one of the second end and the body portion of the collection means includes a filter portion. A handle means is connected to the housing means, and, a power source means is operatively associated with the driving means and physically separated from the housing, the airflow generation means, and the driving means.

In one embodiment, the at least one living subject is an insect. Further, the cross-sectional shape of the housing means is substantially circular, and the body portion of the housing means is substantially cylindrical along the longitudinal axis. At least a portion of the driving means is attached to an inner surface of the body portion of the housing means. Also, at least a portion of the handle means extends from the housing means in a direction that is substantially parallel to the longitudinal axis of the housing means, and at least a portion of the handle means is attached to an external surface of the housing means. In this embodiment, the power source means includes a portable battery.

In another aspect, the present invention relates to a device for capturing at least one insect by a human user. In one embodiment, the device includes a housing having a first end defining a first opening, an opposite, second end defining a second opening, and a body portion defined between the first end and the second end and forming a bore inside along the longitudinal axis. An airflow generator having an electrically-powered fan is operatively associated with the housing, and a driver with an electric motor is electrically connected to the electrically-powered fan of the airflow generator. The device further includes a collector received at least partially within the housing, which has a first end defining an opening proximate to the first opening of the housing, an opposite, second end, and a body portion defined between the first end and the second end. At least one of the second end and the body portion of the collector includes a filter. A handle is attached proximate to the second end of the housing, a portable power source electrically connected to the driver and physically separated from the housing, the airflow generator, and the driver, and an adjustable length shaft having a first end selectively attachable to the handle, an opposite, second end, and a body portion defined between the first end and the second end and defining a bore inside along the longitudinal axis.

In one embodiment, the device also includes an electrical power cord received at least partially inside the bore of the adjustable length shaft, with a first end electrically coupled with the driver and an opposite, second end electrically coupled with the portable power source. The filter of the collector is adapted for blocking the passage of insects and allowing the passage of air. At least a part of the handle is adapted for engaging with the human user. A portable container is adapted for containing the portable power source and physically supporting the portable power source. The portable container includes a harness adapted for engaging with the human user.

In yet another aspect, the present invention relates to a capturing means for capturing at least one living subject by a human user. In one embodiment, the capturing means includes a housing means and an airflow generation means received at least partially within the housing means, for creating a vacuum force. The vacuum force that is created causes air and the at least one living subject to flow into the housing means, at least a portion of the air flowing into the housing means to flow through the housing means, and at least a portion of the air flowing through the housing means to flow out of the housing means. The capturing means also includes a driving means that is attached to the housing means and operatively associated with the airflow generation means, for driving the airflow generation means. A collection means is received at least partially within the housing means, for retaining the at least one living subject flowing into the housing and collected inside. A handle means is attached to the housing means, for engaging with the human user and physically supporting the housing means, and a power source means is operatively associated with the driving means and physically separated from the housing means, airflow generation means, and driving means. The power source means, which is portable, supplies power to the driving means. The airflow generation means is electrically connected to the driving means and the driving means is electrically connected to the power source means.

In one embodiment, the capturing means further includes a harness means for attaching the power source means to the human user, and an adjustable length extension means that is selectively attachable to the handle means, for adjustably providing a separation distance between the housing means and the human user and for physically supporting the housing means.

These and other aspects of the present invention will become apparent from the following description of the preferred embodiments, taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 schematically shows a partial view of a device for capturing at least one living subject, according to one embodiment of the present invention;

FIG. 1A schematically shows a partial view of the collector assembly for the device according to the embodiment shown in FIG. 1;

FIG. 1B shows a disassembled collector assembly for the device according to the embodiment shown in FIG. 1, with partial views of the housing means, collection means, airflow generation means, driving means, and handle means;

FIG. 1C schematically shows a partial view of an adjustable length shaft for the device according to the embodiment shown in FIG. 1; and

FIG. 2 schematically shows a partial view of a second configuration of a device for capturing at least one living subject, according to another embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

### Definitions

The terms used in this specification generally have their ordinary meanings in the art, within the context of the invention, and in the specific context where each term is used.

Certain terms that are used to describe the invention are discussed below, or elsewhere in the specification, to provide additional guidance to the practitioner in describing the apparatus and methods of the invention and how to make and use them. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the invention or of any exemplified term. Likewise, the invention is not limited to various embodiments given in this specification. Furthermore, subtitles may be used to help a reader of the specification to read through the specification, which the usage of subtitles, however, has no influence on the scope of the invention.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

### OVERVIEW OF THE INVENTION

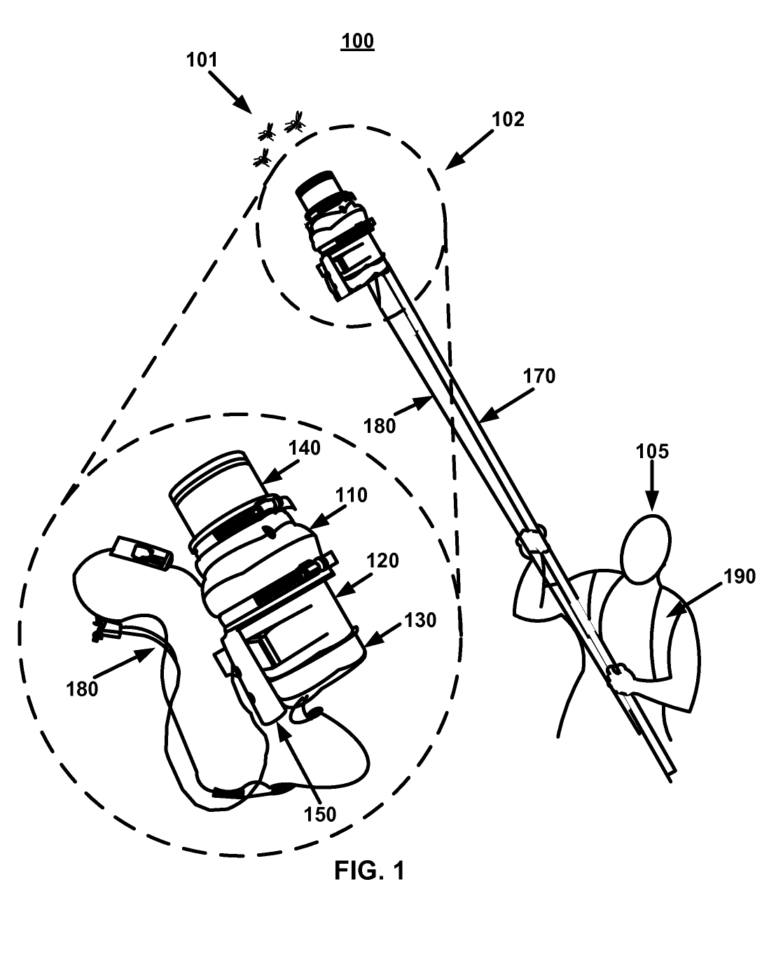

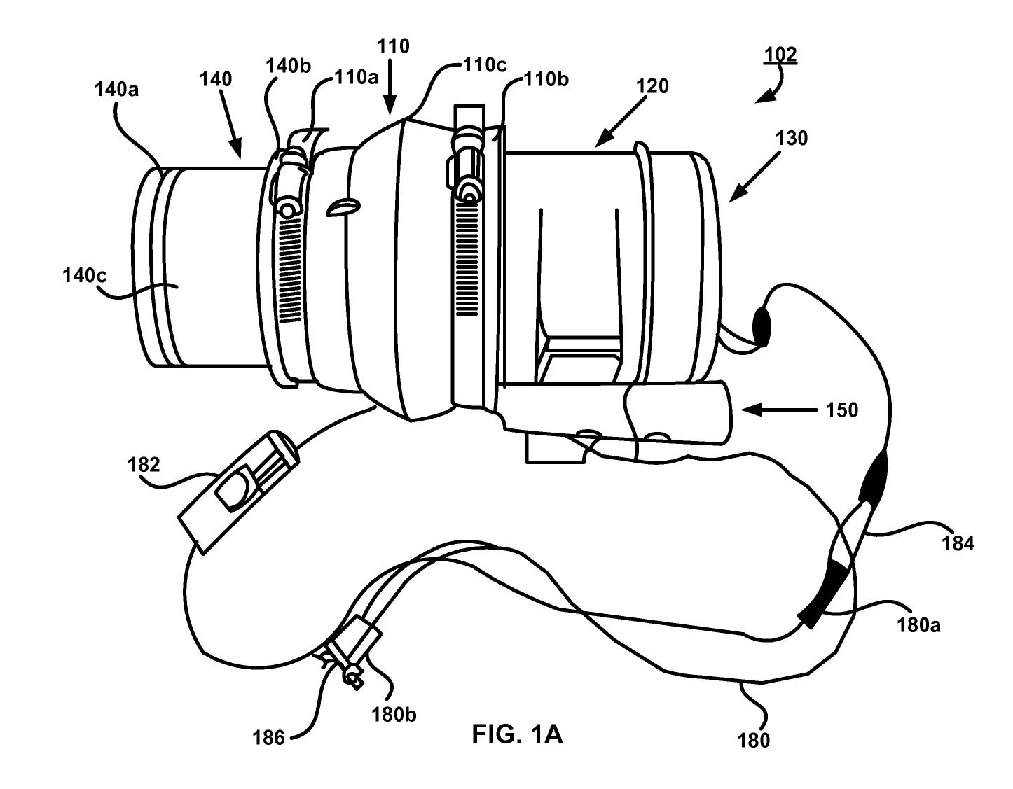

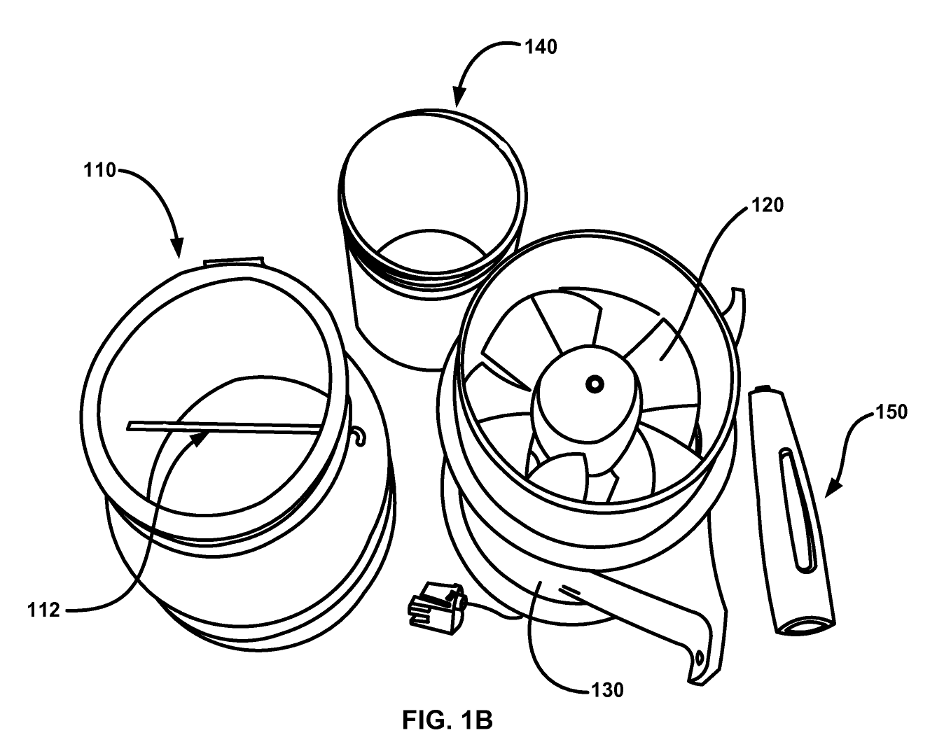

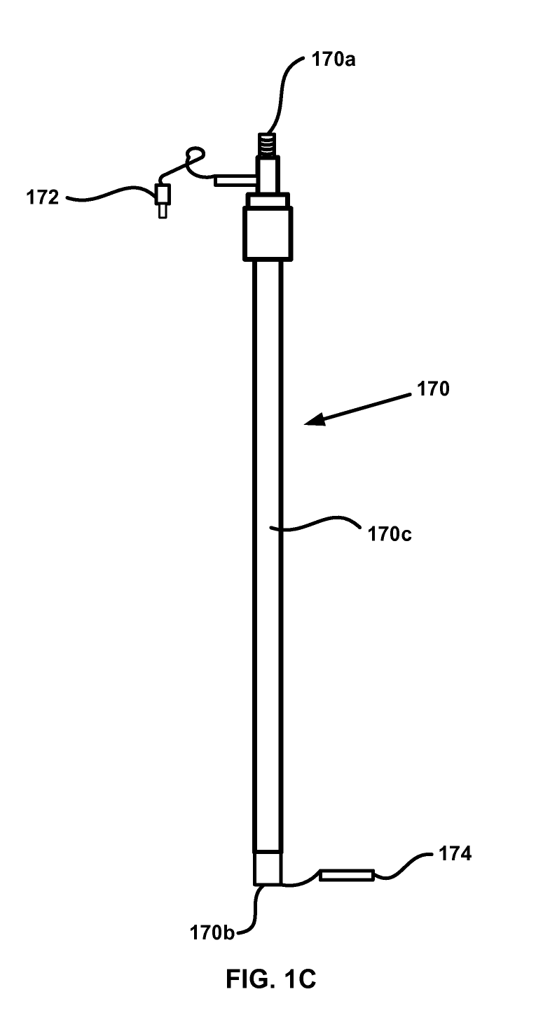

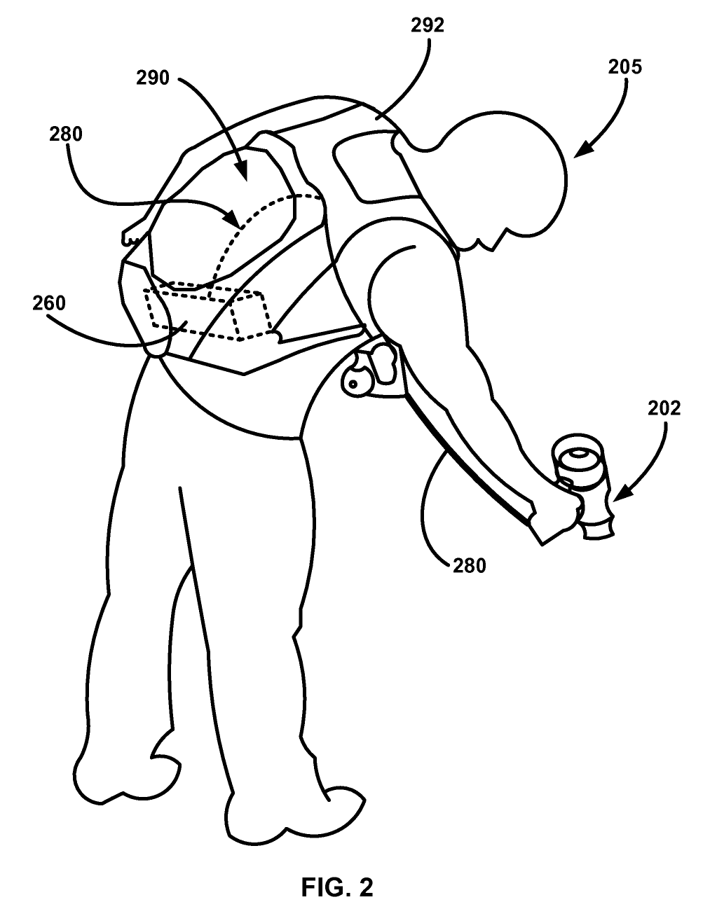

The description will be made as to the embodiments of the present invention in conjunction with the accompanying drawings in FIGS. 1, 1A, 1B, 1C, and 2. Now referring to FIGS. 1, 1A, 1B, and 1C, the present invention, in one aspect, relates to a device 100 for capturing at least one living subject 101. In one embodiment, the living subject 101 is a mosquito. The device 100 includes a housing means 110 having a first end 110a defining a first opening, an opposite second end 110b defining a second opening, and a body portion 110c defined between the first end 110a and the second end 110b and forming a bore inside along the longitudinal axis. The device 100 also includes an airflow generation means 120 that is operatively associated with the housing means 110, a driving means 130 that is operatively associated with the airflow generation means 120, and a collection means 140 that is received at least partially within the housing means 110.

The collection means 140 has a first end 140a defining an opening proximate to the first opening of the housing means 110, an opposite, second end 140b, and a body portion 140c defined between the first end 140a and the second end 140b. At least one of the second end 140b and the body portion 140c of the collection means 140 comprises a filter portion. The device 100 further includes a handle means 150 that is connected to the housing means 110, and a power source means (see, e.g. FIG. 2) that is operatively associated with the driving means 130. The power source means is physically separated from the housing means 110, the airflow generation means 120, and the driving means 130. The power source means includes a portable battery. Collectively, the housing means 110, airflow generation means 120, driving means 130, collection means 140, and handle means 150 form a collector assembly 102.

In one embodiment, at least a portion of the driving means 130 is attached inside the body portion 110c of the housing means 110 at one or more points, such as on an inner surface. At least a portion of the handle means 150 extends from the housing means 110 in a direction that is substantially parallel to the longitudinal axis of the housing means 110, and at least a portion of the handle means 150 is attached to an external surface of the housing means 110.

As shown in FIG. 1, the cross-sectional shape of the housing means 110 is substantially circular and the body portion 110c of the housing means 110 is substantially cylindrical along the longitudinal axis. However, the shape of the cross-section may alternatively be a polygon or an elongated circle. Further, the body portion 110c of the housing means 110 may alternatively take one or more forms other than a cylinder along the longitudinal axis, such as that of an elongated prism.

In another aspect, the present invention relates to a device 100 for capturing at least one insect 101 by a human user 105. In one embodiment, the device 100 includes a housing 110 with a first end 110a defining a first opening, an opposite, second end 110b defining a second opening, and a body portion 110c defined between the first end 110a and the second end 110b and forming a bore inside along the longitudinal axis. The device 100 also includes an airflow generator 120 having an electrically-powered fan that is operatively associated with the housing 110, a driver 130 having an electric motor that is electrically connected to the electrically-powered fan of the airflow generator 120, and a collector 140 that is received at least partially within the housing 110. The collector 140 has a first end 140a defining an opening that is proximate to the first opening of the housing 110, an opposite, second end 140b, and a body portion 140c defined between the first end 140a and the second end 140b. At least one of the second end 140b of the collector 140 and the body portion 140c of the collector 140 includes a filter. The filter is adapted for blocking the passage of insects (e.g. insect 101, FIG. 1) and allowing the passage of air, such as through the use of wire mesh. A handle 150 is attached proximate to the second end 110b of the housing 110, and a portable power source (see FIG. 2) is electrically connected to the driver 130 and physically separated from the housing 110, the airflow generator 120, and the driver 130. At least a portion of the handle 150 is adapted for engaging with the human user 105. For example, the handle 150 may have an external surface that is adapted to be grasped by the hands of the human user 105.

Now referring specifically to FIG. 1B, a disassembled view of the collector assembly 102 is shown, including partial views of each of the housing 110, airflow generator 120, driving means 130, and handle 150. As shown, a separation member 112 is disposed within the bore of the housing 110, to physically separate collected mosquitoes in the collector 140 at a predetermined distance from the airflow generator 120. In the embodiment shown, the separation member 112 is a thick wire, but substitute or additional separation components such as wire mesh may also be utilized.

In one embodiment, the device 100 also includes an adjustable length shaft 170 with a first end 170a that is selectively attachable to the handle 150. Internal surfaces of the handle are threaded to allow the first end 170a to be securely engaged inside. The adjustable length shaft 170 also has an opposite, second end 170b, and a body portion 170c defined between the first end 170a and the second end 170b and which defines a bore inside along the longitudinal axis. In one embodiment, an electrical power cord 180 is received at least partially inside the bore of the adjustable length shaft 170. Alternatively, the power cord 180 may run outside of the shaft 170 from the first end 170a to the second end 170b. The power cord 180 has a first end 180a that is electrically coupled with the driver 130 via a first connector 184, and an opposite, second end 180b that is electrically coupled with the portable power source (see FIG. 2) via a second connector 186. An in-line on/off switch 182 is operatively coupled to the power cord 180 to allow a user (see, e.g. user 105) to selectively activate or deactivate operation of the device 100 by actuating the switch 182. In an embodiment in which the power cord 180 partially runs inside the adjustable length shaft 170 from the first end 170a to the second end 170b, such as using the configuration shown in FIG. 1C, a first connector 172 proximate to the first end 170a is configured to electrically couple with the first connector 184 shown in FIG. 1A, and a second connector 174 proximate the second end 170b is configured to electrically couple with the second connector 186 shown in FIG. 1A.

In one embodiment, the device 100 further includes a portable container 190 that is adapted for containing the portable power source (see FIG. 2) and/or physically supporting the portable power source. The portable container 190 has a harness that is adapted for engaging with the human user 105. In the embodiment shown, the portable container 190 is shown in the form of a backpack with shoulder straps.

In yet another aspect, the present invention relates to a capturing means 100 for capturing at least one living subject 101 by a human user 105. In one embodiment, the capturing means includes a housing means 110 and an airflow generation 120 means that is received at least partially within the housing means 110. The capturing means 100 also includes a driving means 130 that is attached to the housing means 110. The driving means is operatively associated with the airflow generation means 120 and is adapted for driving the airflow generation means 120. A collection means 140 is received at least partially within the housing means 110, for retaining the at least one living subject 101 flowing into the housing means 110 and collected inside. A handle means 150 is attached to the housing means 110, for engaging with the human user 105 and physically supporting the housing means 110. A power source means (see FIG. 2) is operatively associated with the driving means 130 and is physically separated from the housing means 110, airflow generation means 120, and driving means 130, for supplying power to the driving means 130.

The airflow generation means 120 is electrically connected to the driving means 130, and the driving means 130 is electrically connected to the power source means. The power source means (see FIG. 2) is a portable source of electrical power, such as a battery. The airflow generation means 120 is adapted for creating a vacuum force for causing air and at least one living subject 101 to flow into the housing means 110, causing at least a portion of the air flowing into the housing means 110 to flow through the housing means 110, and causing at least a portion of the air flowing through the housing means 110 to flow out of the housing means 110.

In one embodiment, the capturing means 100 further includes an adjustable length extension means 170 that is selectively attachable to the handle means 150, for adjustably providing a separation distance between the housing means 110 and the human user 105 and for physically supporting the housing means 110. The extension means 170 is configured to adjust telescopically in order to extend and retract according to a desired length for capturing a living subject such as a mosquito located outside of the reach from a human user 105. A harness means 190 attaches the power source means to the human user 105. The harness means may include shoulder straps.

Now referring to FIG. 2, a second configuration of a device for capturing insects is shown, according to one embodiment of the present invention. As shown, the human user 205 is wearing a backpack 290 with shoulder straps for supporting and containing a portable power source 260 inside, where the power source 260 is operative to supply power to the driving means 130 of the collector assembly 202 and is connected to the collector assembly 202 by a power cord 280. In this embodiment, the user 205 grasps the handle 250 and manually moves the assembly 102 into target areas for collecting insects that are within reach of the user 205 without the need of an extension means such as the adjustable length extendible shaft 170 shown in the embodiment of FIG. 1.

### EXAMPLES AND IMPLEMENTATIONS OF THE INVENTION

Without intent to limit the scope of the invention, exemplary devices and related results of their use according to embodiments of the present invention are given below. Certain theories may be proposed and disclosed herein; however, in no way they, whether right or wrong, should limit the scope of the invention.

### Example 1

This example illustrates a mosquito aspirator for collecting insects using a light-suction vacuum effect, according to one embodiment of the present invention. The aspirator was created from a four inch, rule model 240, in-line blower originally designed for boat ventilation systems. A 4:3 inch flexible rubber coupling was added to the sucking end of the blower. Between the coupler and the fan, a piece of metal mesh was added to prevent the collection cups from hitting the fan. A threaded handle from a paint roller was attached to the side of the blower using wire. A 6 to 12 foot adjustable length extension painting pole was threaded with a telephone style, coiled, electric wire to allow for easy extension and collapse of the pole without excess wire around. Straight wire was connected to a 12 VDC 17 AmpHR sealed-electrolyte battery using ring terminals and screws. Ballast disconnects were used to connect the blower fan to the extension pole and the extension pole to the battery in the same direction so that the fan can be disconnected from the pole and connected directly to the straight wire from battery. An in-line on/off twist switch was added between the battery and the first ballast disconnect. Screened collection cups fit into the 3 inch side of the 4-to-3 inch rubber coupling.

### Example 2

This example illustrates a mosquito aspirator according to another embodiment of the present invention. In this embodiment, the aspirator has a light-weight motor located close to collection cups, and a 12V battery is mounted on the operator's back, thereby reducing the overall weight of the collector assembly. A commercially available four inch in-line blower originally designed for boat ventilation systems, and specifically a Rule model 240 available from ITT Co. of White Plains, N.Y. was used as the battery-powered motor. The Rule model 240 provides for ample suction power, and is also light weight (0.5 Kg), has a low rate of power consumption (4.3 Amps), and it water-resistant. A 4:3 inch flexible rubber coupling, and specifically a PlumbQuik model P1056-43 available from Fernco Inc. of Davison, Mich. was added to the aspirating end of the blower. A thick wire and piece of metal mesh were added between the coupler and the fan, to separate the cups that contain captured mosquitoes from the fan. Electrical straight wire with an on/off switch was connected to a 12 VDC 17 AmpHR sealed-electrolyte battery, available from Enersys of Reading, Pa. A threaded handle from a paint roller was threaded with a coiled, telephone style electric wire to allow for easy extension and collapse of the pole without excess wire. Without the battery, the total weight of the aspirator is 0.88 kg, and the total weight is 3.0 kg with the battery.

### Trials

From Nov. 24, 2008 to Mar. 11, 2009, two combined sewer overflow (CSO)

tunnels (Greensferry and Tanyard Creek) of the city of Atlanta, Ga. were visited to collect

overwintering mosquitoes using the above-described embodiment of the aspirator according to aspects of the present invention. The upper walls (above 1.5 m) and ceiling of seven, 10 m sections of the tunnels (3 in Greensferry and 4 in Tanyard) were carefully aspirated by three field technicians. The collection effort was fixed at approximately 20 minutes per tunnel. The tunnel concrete surface walls were uneven and required maneuvering around pipes and drains. The ceilings were high (up to 5 meters), and some surfaces were partially wet. Collected mosquitoes were kept alive in glass breeding chambers (30×30×30 cm) containing a 10% sucrose solution and then identified by species and individually stored at −80° C. for further virus testing.

During May 7-22, 2009, the above-described embodiment was used in an experimental trial performed in 71 houses of the city of Iquitos, Peru. Randomly selected houses were visited by two field technicians who tested the performance of the mosquito aspirator in indoor collections. An extension pole, as described above in connection with aspects of the present invention, was utilized to collect mosquitoes resting on the higher (>1.5 m) walls and the ceiling at each house. Collection effort in each house was fixed at approximately 10 minutes. Aspiration was performed in all rooms and hallways of each house.

### Results

92 mosquitoes were collected in CSO tunnels of Atlanta using the above-described embodiment of the aspirator (24 and 68 mosquitoes collected in the upper wall and the ceiling, respectively). The percentage of tunnel sections infested by overwintering mosquitoes on the upper wall and ceiling (21.4%) was much higher than on the lower wall (7.1%). From the identified mosquitoes, 96.7% were Culex pipiens complex, 2.2% Culex territans, and 1.1% Culex erraticus. Further, bloodfeed Ae aegypti females were collected using the above-described aspirator at a statistically significant improved rate as compared to those collected using a conventional aspirator [4], due at least in part to the above-described embodiment's superior ability to reach mosquito resting places. No signs of damage were observed in the collected mosquitoes, and they survived at room temperature for an average of 3.4 days (SD, 2.4 days) after being collected.

The improvement in collecting bloodfed mosquitoes with the above-described aspirator is of particular importance in epidemiological studies of disease vectors. Results evidence the effectiveness of the aspirator to collect different mosquito species in different epidemiological settings. The above-described aspirator in accordance with one embodiment of the present invention will not only allow for an increase the coverage (one team of two technicians can cover up to 20-30 houses a day) but also for an improvement in the quality of the entomologic data obtained, particularly for bloodfed mosquitoes. Also, the lower cost of the aspirator ($45 to $70) will make it affordable for countries where limited financial resources are available for mosquito surveillance.

While there have been shown several and alternate embodiments of the present invention, it is to be understood that certain changes can be made as would be known to one skilled in the art without departing from the underlying scope of the invention as is discussed and set forth above and below including claims. Furthermore, the embodiments described above and claims set forth below are only intended to illustrate the principles of the present invention and are not intended to limit the scope of the invention to the disclosed elements.

### LIST OF REFERENCES

[1] Lehane, M. J., The Biology of Blood-Sucking in Insects, Cambridge University Press, Cambridge, UK, 2nd 186 ed., 2005.
[2] Silver, J. B., Mosquito Ecology: Field Sampling Methods, Springer, N.Y., 3rd ed., 2008.
[3] Scott, T. W. and Morrison, A. C., “Longitudinal field studies will guide a paradigm shift in dengue prevention,” Vector-borne Diseases: Understanding the Environmental, Human Health, and Ecological Connections, National Academies Press, Washington, D.C., 2008.
[4] Clark, G. C., Seda, H., and Gubler, D. J. “Use of the ‘CDC Backpack Aspirator’ for Surveillance of Aedes aegypti in San Juan, Puerto Rico.” J. Am. Mosq. Control Assoc. 10:119-124.

What is claimed is:

1. A device for capturing at least one living subject, comprising:
(a) a housing means having a first end defining a first opening, an opposite second end defining a second opening, and a body portion defined between the first end and the second end and forming a bore therein along the longitudinal axis;
(b) an airflow generation means disposed within the housing means;
(c) a driving means disposed within the housing means and operatively associated with the airflow generation means;
(d) a collection means received at least partially within the housing means, having a first end defining an opening proximate the first opening of the housing means, an opposite, second end, and a body portion defined between the first end and the second end, and wherein at least one of the second end and the body portion comprises a filter portion;
(e) a handle means connected to the housing means;
(f) a power source means operatively associated with the driving means and physically separated from the housing means.

2. The device of claim 1, wherein the at least one living subject is an insect.

3. The device of claim 1, wherein the cross-sectional shape of the housing means is substantially circular.

4. The device of claim 1, wherein the body portion of the housing means is substantially cylindrical along the longitudinal axis.

5. The device of claim 1, wherein at least a portion of the driving means is attached to an inner surface of the body portion of the housing means.

6. The device of claim 1, wherein at least a portion of the handle means extends from the housing means in a direction that is substantially parallel to the longitudinal axis of the housing means.

7. The device of claim 1, wherein at least a portion of the handle means is attached to an external surface of the housing means.

8. The device of claim 1, wherein the power source means comprises a battery.

9. A device for capturing at least one insect, comprising:
(a) a housing having a first end defining a first opening, an opposite, second end defining a second opening, and a body portion defined between the first end and the second end and forming a bore therein along the longitudinal axis;
(b) an airflow generator disposed within the housing means and having an electrically-powered fan that is operatively associated with the housing;
(c) a driver disposed within the housing means and having an electric motor that is electrically connected to the electrically-powered fan of the airflow generator;
(d) a collector received at least partially within the housing, having a first end defining an opening that is proximate to the first opening of the housing, an opposite, second end, and a body portion defined between the first end and the second end, and wherein at least one of the second end and the body portion comprises a filter;
(e) a handle attached proximate to the second end of the housing;
(f) a portable power source electrically connected to the driver and physically separated from the housing; and
(g) an adjustable length shaft having a first end that is selectively attachable to the handle, an opposite, second end, and a body portion defined between the first end and the second end and defining a bore therein along the longitudinal axis.

10. The device of claim 9, further comprising an electrical power cord received at least partially inside the bore of the adjustable length shaft, having a first end electrically coupled with the driver and an opposite, second end electrically coupled with the portable power source.

11. The device of claim 9, wherein the filter of the collector is adapted for blocking the passage of insects and allowing the passage of air.

12. The device of claim 9, wherein at least a part of the handle is adapted for being engageable by a human user.

13. The device of claim 9, further comprising a portable container adapted for at least one of containing the portable power source and physically supporting the portable power source.

14. The device of claim 13, wherein the portable container comprises a harness adapted for being engageable by a human user.

15. A capturing means for capturing at least one living subject, comprising:
(a) a housing means;
(b) an airflow generation means received at least partially within the housing means, for creating a vacuum force for:
(i) causing air and at least at least one living subject to flow into the housing means;
(ii) causing at least a portion of the air flowing into the housing means to flow through the housing means; and
(iii) causing at least a portion of the air flowing through the housing means to flow out of the housing means;
(c) a driving means attached within the housing means and operatively associated with the airflow generation means, for driving the airflow generation means;
(d) a collection means received at least partially within the housing means, for retaining the at least one living subject flowing into the housing means inside the housing means;
(e) a handle means attached to the housing means for physically supporting the housing means; and
(f) a power source means operatively associated with the driving means and physically separated from the housing means, for supplying power to the driving means.

16. The capturing means of claim 15, wherein the airflow generation means is electrically connected to the driving means.

17. The capturing means of claim 15, wherein the driving means is electrically connected to the power source means.

18. The capturing means of claim 15, further comprising an adjustable length extension means that is selectively attachable to the handle means, for adjustably providing a separation distance between the housing means and a human user and for physically supporting the housing means.

19. The capturing means of claim 15, wherein the power source means is a portable source of electrical power.

20. The capturing means of claim 19, further comprising a harness means for attaching the power source means to a human user.
